(19) United States
(12) Patent Application Publication
(10) Pub. No.: US 2025/0204736 A1
(43) Pub. Date: Jun. 26, 2025

(54) VACUUM CLEANER THAT WORKS BY TRIGGERING VIBRATION SENSOR

(71) Applicants: SainStore Technology Co., Ltd., Dongguan (CN); Suzhou Inotek Intelligent Technology Co., Ltd., Suzhou (CN)

(72) Inventor: Mingyang Ding, Suzhou (CN)

(21) Appl. No.: 18/989,859

(22) Filed: Dec. 20, 2024

(30) Foreign Application Priority Data
Dec. 25, 2023 (CN) 2023117974024

(51) Int. Cl. A47L 9/28; A47L 9/14; A47L 9/24

(52) U.S. Cl. CPC A47L 9/2805; A47L 9/1409; A47L 9/1463; A47L 9/248; A47L 9/2842; A47L 9/2889

(57) ABSTRACT

A vacuum cleaner that works by triggering a vibration sensor, comprising a housing, the housing is provided with an inlet and an outlet, the inlet is arranged at a bottom of the housing, a motor and a dust bin are arranged in the housing, the motor comprises a suction port and an exhaust port, the inlet is connected to the dust bin, the dust bin is connected to the motor, the exhaust port is connected to the outlet; the housing is also provided with a first sensor, the first sensor is configured to detect whether there is garbage swept near the vacuum cleaner. The spring-type vibration sensor is closely attached to the vacuum cleaner's housing, achieving both anti-interference and sensitivity. The invention adopts the design that the direction of the spring's expansion and contraction for detecting sensitivity is aligned with the movement direction of the cleaning tool.

### 1. TECHNICAL FIELD

The invention relates to the technical field of vacuum cleaning, in particular to a vacuum cleaner that works by triggering a vibration sensor.

### 2. BACKGROUND ART

Vacuum cleaners are indispensable electrical appliances for cleaning in both household and commercial environments. Cleaning large amounts of hair and garbage requires vacuum cleaners with large capacities and the ability to operate continuously. Traditional household upright and canister vacuum cleaners often have smaller capacities, and they need to be plugged in before use, then be stored after use; during operation, there may also be problems such as hair wrapping around the floor brush and the inability to promptly clean up large amounts of garbage. On the other hand, while an increasing number of vacuum cleaners powered by lithium batteries, such as stick-type vacuum cleaners and automatic robotic vacuum cleaners, are available, they face challenges such as limited battery life, small capacity, and the same problems of hair wrapping, which cannot be effectively addressed when dealing with large amounts of hair and garbage.

The above-mentioned problems are more prominent in commercial establishments, such as salons and pet shops, as these places generate large amounts of hair and debris every day, requiring timely cleaning and centralized disposal. Due to the limitations of household vacuum cleaners and the fact that ordinary commercial vacuum cleaners also consume a lot of labor, such as maintaining the vacuum cleaner, bending over, cleaning, and frequent emptying of the dustbin, etc.

The “Eyevac” branded trash can vacuum cleaner, invented by the American company Crowleyjones, L.P., has been introduced into the market as a product tailored for the aforementioned cleaning scenarios. It addresses the aforementioned pain points by featuring a large capacity for collecting hair, continuous operation, and automatic waste retrieval in coordination with brooms.

However, Eyevac's sensor is an infrared proximity sensor. Its working principle is that in sensor mode, when the vacuum cleaner sensor senses the approach of the broom, the sensor will turn on the vacuum cleaner circuit and suck the garbage near the suction port into the trash can.

The operation of Eyevac effectively solves the hassle of manually activating the vacuum cleaner's circuit, reducing the burden of cleaning. However, due to the characteristics of the infrared proximity sensor, the following two problems arise: 1. the infrared sensor has poor sensitivity to dark-colored objects; when a black broom approaches the vacuum cleaner, it cannot start automatically; this requires guiding consumers to purchase light-colored brooms or avoid using the sensor mode to activate the vacuum. 2. In the proximity sensor mode, the vacuum cleaner responds to any object within the detection range, which can lead to false triggers; for example, there have been instances where a pet mouse passed by the vacuum cleaner and was sucked into it, leading to its death; there are also frequent cases where pets, upon passing near the vacuum, trigger the sensor and get frightened. In response to the problem of false triggering in this sensor mode, Eyevac only offers the option to turn off the sensor and switch to manual mode, which limits the convenience and applicability of the product in certain scenarios.

In view of the above problems, this invention proposes a new solution.

### 3. SUMMARY OF THE INVENTION

In order to solve at least one of the technical problems existing in the existing prior art, the invention provides a vacuum cleaner with good anti-interference performance and high sensitivity. The specific scheme is as follows:
a vacuum cleaner that works by triggering a vibration sensor, comprising a housing, the housing is provided with an inlet and an outlet, the inlet is arranged at a bottom of the housing, a motor and a dust bin are arranged in the housing, the motor comprises a suction port and an exhaust port, the inlet is connected to the dust bin, the dust bin is connected to the motor, the exhaust port is connected to the outlet;
the housing is also provided with a first sensor, the first sensor is a vibration sensor, the vibration sensor is configured to detect whether a broom or other cleaning tools have collided with the housing.

As an optimal scheme of the invention, the first sensor is arranged on the housing near the inlet.

As an optimal scheme of the invention, the first sensor is a spring-type vibration sensor; the direction of the spring's expansion and contraction for detecting sensitivity is aligned with the movement direction of the cleaning tool.

As an optimal scheme of the invention, multiple vibration sensors are arranged at intervals on the housing, and the multiple vibration sensors are connected in parallel.

As an optimal scheme of the invention, the inlet is connected to the dust bin through a pipeline, at least a portion of the pipeline is placed outside the housing, the portion of the pipeline outside the housing is at least partially a hose, a detachable structure is located at one end of the hose near the inlet, one end of the hose near the detachable structure is a hose suction nozzle.

As an optimal scheme of the invention, a second sensor is arranged on the detachable structure, and the second sensor is configured to detect whether the hose has been detached from the detachable structure.

As an optimal scheme of the invention, the invention further comprises a control system, the control system comprises a control module, the control system is provided with a manual mode and an automatic mode, both the manual mode and the automatic mode are connected to the motor through a motor control module on the control module, and the automatic mode is also connected to the first sensor.

As an optimal scheme of the invention, vacuuming methods of the vacuum cleaner comprise a floor mode and an accessory mode; when the second sensor detects that the hose suction nozzle has been removed from the detachable structure, the suction mode is configured by the control system to the accessory mode; when the second sensor detects that the hose suction nozzle has not been removed from the detachable structure, the suction mode is configured by the control system to the floor mode.

As an optimal scheme of the invention, the floor mode is initially configured by the control system to high-power suction, and the accessory mode is initially configured by the control system to low-power suction.

Preferably, when the vacuum cleaner is in the accessory mode, pressing a mode switching button will switch the low-power suction of the accessory mode to high-power suction.

As an optimal scheme of the invention, the dust bin is detachably arranged on the housing, a mistake-proofing sensor is arranged on the housing, the mistake-proofing sensor is configured to detect whether the dust bin is opened or removed.

Compared with the prior art, the technical scheme of the invention has at least one or more of the following advantageous effects:
the spring-type vibration sensor is closely attached to the vacuum cleaner's housing, achieving both anti-interference and sensitivity. By adopting the design that the direction of the spring's expansion and contraction for detecting sensitivity is aligned with the movement direction of the cleaning tool, it ensures that during actual use, actions such as moving the vacuum cleaner, the operation of the vacuum cleaner itself, and touches in non-cleaning directions will not easily mistakenly trigger the vacuum cleaner to operate; the sensitivity in the cleaning direction is also guaranteed. The spring-type vibration sensor differs from the ball-type vibration sensor. Although the ball-type vibration sensor has high sensitivity and is used for detecting displacement and vibration, vibrations from moving the vacuum cleaner, the motor's own movement, or even vibrations from the ground during use may inadvertently trigger the vacuum cleaner to operate.

The research and development team of the invention was inspired by the observation that during the sweeping process, the broom needs to concentrate the debris towards the inlet, which results in continuous collisions with the outer housing of the device. Based on this observation, they selected a vibration sensor to start the vacuum cleaner, using vibration as a necessary condition for determining the cleaning intention.

The technical scheme of this invention not only addresses the problem of automatically activating the vacuum cleaner using sensors, but also effectively resolves the problem of infrared sensors being insensitive to dark-colored objects and prone to false triggering. When the vacuum cleaner is in a mode where its vibration sensor is activated, upon detecting a slight collision of a broom with the vacuum cleaner's housing, the vacuum cleaner is immediately turned on to suction up garbage. After the collision ceases, it continues to operate for a preset duration before stopping, maintaining this cycle of operation until another collision is detected and the process repeats. When there is no collision and the vacuum cleaner is inactive, it will not be falsely triggered by nearby objects, and there are no color restrictions for cleaning tools such as brooms. This fundamentally avoids the drawbacks associated with other sensor products, such as infrared or ultrasonic sensors.

By using multiple vibration sensors, the contact area with high sensitivity is increased; the vibration sensors are arranged at intervals, the installation spacing is widened, thereby improving the overall sensitivity across the entire cleaning surface.

The hose is provided, and the hose is clipped into the buckle slot. During use, the hose suction nozzle is removed from the detachable structure, and the hose body can be taken out from the buckle slot for use. This design does not take up extra space and is convenient for carrying and use.

The mistake-proofing sensor and the mistake-proofing module play a mistake-proofing role, that is, if the mistake-proofing sensor detects that the dust bin is opened or removed, the vacuum cleaner will not work no matter how the start button is pressed.

The first filter is provided to prevent the garbage dust in the dust bin from entering the motor and affecting the life of the motor. The second filter is provided to prevent dust falling inside the housing from being discharged outside the housing. Through the visual window, the garbage collection situation in the dust bin can be observed.

The additional aspects and advantages of the invention will be partially provided in the following description, and will be partially apparent from the description below or understood through the practice of the invention.

### 4. BRIEF DESCRIPTION OF ACCOMPANY DRAWINGS

In order to explain the technical schemes in the embodiments of the invention or prior art more clearly, the accompanying drawings needed to be used in the description of the embodiments or the prior art will be briefly introduced below. Obviously, the accompanying drawings in the following description are only are some embodiments of the invention. For those of ordinary skill in the art, other accompanying drawings can be obtained based on these accompanying drawings without exerting creative efforts.

FIG. 1 is a schematic diagram of the exploded structure of the vacuum cleaner of the invention from one viewing angle.

FIG. 2 is a schematic diagram of the exploded structure of the vacuum cleaner of the invention from another viewing angle.

FIG. 3 is a schematic diagram of the three-dimensional structure of the vacuum cleaner of the invention from one viewing angle.

FIG. 4 is a schematic diagram of the three-dimensional structure of the vacuum cleaner of the invention from another viewing angle.

FIG. 5 is a schematic diagram of the logical structure of the manual mode/automatic mode of the vacuum cleaner of the invention.

In the figures: 1 housing, 2 dust bin, 3 control button, 11 inlet, 12 outlet, 121 second filter, 13 first sensor, 14 pipeline, 141 hose, 142 detachable structure, 15 mistake-proofing sensor, 21 handle, 22 visual window, 31 power switch, 32 activation button, 33 mode switching button, 34 display panel.

### 5. SPECIFIC EMBODIMENT OF THE INVENTION

The following is a detailed description of embodiments of the invention, examples of the embodiments are shown in the accompanying drawings; the same or similar reference numerals throughout represent the same or similar elements or elements having the same or similar functions. The embodiments described below with reference to the accompanying drawings are exemplary and intended to be used to explain the present invention, but should not be construed as limiting the present invention. Based on the embodiments of the invention, all other embodiments obtained by ordinary technicians in the field without creative work are within the protection scope of the invention.

In the description of the invention, it should be understood that the orientation or positional relationship indicated by the terms “upper”, “lower”, “top”, “bottom”, “inner”, “outer”, “front”, “rear”, “two end”, “one end”, “the other end” and so on are based on the orientation or positional relationship shown in the accompanying drawings, only for the convenience of describing the invention and simplifying the description, rather than indicating or implying that the indicated device or element must have a specific orientation, as well as a specific orientation structure and operation, therefore, it should not be construed as a limitation of the invention. In the description of the invention, the meaning of “multiple” is two or more, unless otherwise expressly limited. In addition, the terms of “first”, “second”, “third”, “fourth”, “fifth” and so on are only used to describe purposes, and should not be construed as indicating or implying relative importance.

In the description of the invention, unless otherwise expressly specified and limited, the terms “arranged”, “provided”, “connected”, “mounted”, “sleeved”, “disposed”, “fixed” and so on should be understood in a broad sense, for example, it may be a fixed connection or a detachable connection or integral connection; it can be a mechanical connection or an electrical connection; it can be a direct connection or an indirect connection through an intermediate medium, and it can be the internal connection between the two components, or the interaction between two elements. For those skilled in the art, the specific meanings of the above terms in the invention can be understood according to specific situations.

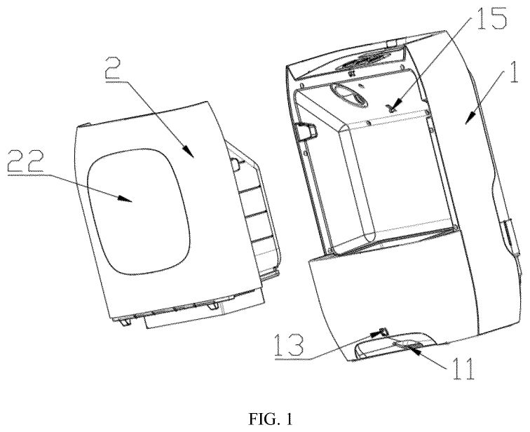

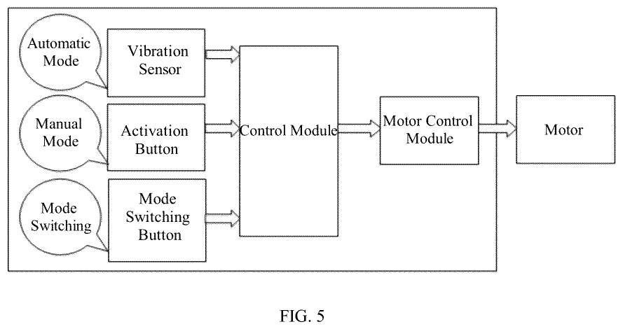

Please refer to FIG. 1 to FIG. 5, the invention provides a vacuum cleaner that works by triggering a vibration sensor, comprising a housing 1, the housing 1 is provided with an inlet 11 and an outlet 12, the inlet 11 is arranged at a bottom of the housing, a motor and a dust bin 2 are arranged in the housing, the motor comprises a suction port and an exhaust port, the inlet is connected to the dust bin 2, the dust bin 2 is connected to the motor, the exhaust port is connected to the outlet 12;
the housing is also provided with a first sensor 13, the first sensor 13 is configured to detect whether there is garbage swept near the vacuum cleaner.

In the embodiment, the motor is arranged below the dust bin 2, and the motor can suck the garbage from the inlet into the dust bin 2. Of course, it is not limited to garbage, but can also be other scattered objects that customers need to collect.

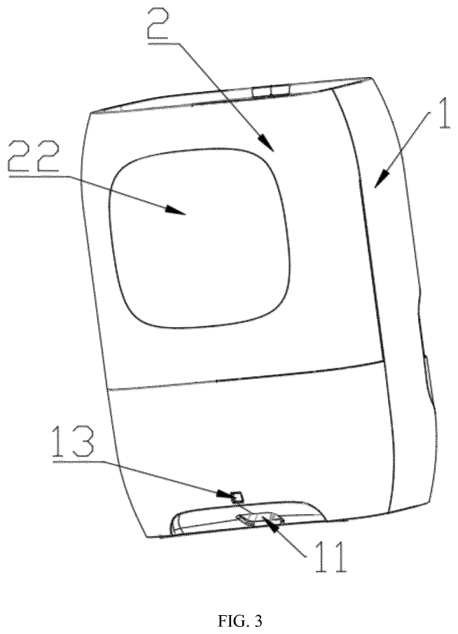

Preferably, as shown in FIG. 1 and FIG. 3, the first sensor 13 is arranged on the housing near the inlet.

In a preferred embodiment, the first sensor 13 is a vibration sensor, the vibration sensor is configured to detect whether a broom or other cleaning tools have collided with the housing. Further preferably, the first sensor 13 is a spring-type vibration sensor; the direction of the spring's expansion and contraction for detecting sensitivity is aligned with the movement direction of the cleaning tool. More preferably, multiple vibration sensors are arranged at intervals on the housing, and the multiple vibration sensors are connected in parallel; by using multiple vibration sensors, the contact area with high sensitivity is increased; the vibration sensors are arranged at intervals, the installation spacing is widened, thereby improving the overall sensitivity across the entire cleaning surface.

The spring-type vibration sensor is closely attached to the vacuum cleaner's housing, achieving both anti-interference and sensitivity. By adopting the design that the direction of the spring's expansion and contraction for detecting sensitivity is aligned with the movement direction of the cleaning tool, it ensures that during actual use, actions such as moving the vacuum cleaner, the operation of the vacuum cleaner itself, and touches in non-cleaning directions will not easily mistakenly trigger the vacuum cleaner to operate; the sensitivity in the cleaning direction is also guaranteed. The spring-type vibration sensor differs from the ball-type vibration sensor. Although the ball-type vibration sensor has high sensitivity and is used for detecting displacement and vibration, vibrations from moving the vacuum cleaner, the motor's own movement, or even vibrations from the ground during use may inadvertently trigger the vacuum cleaner to operate.

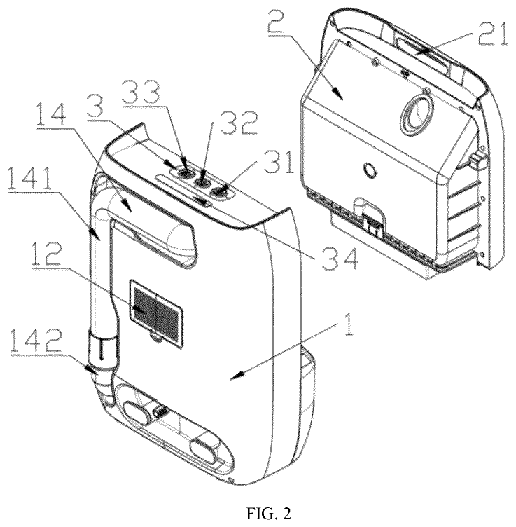

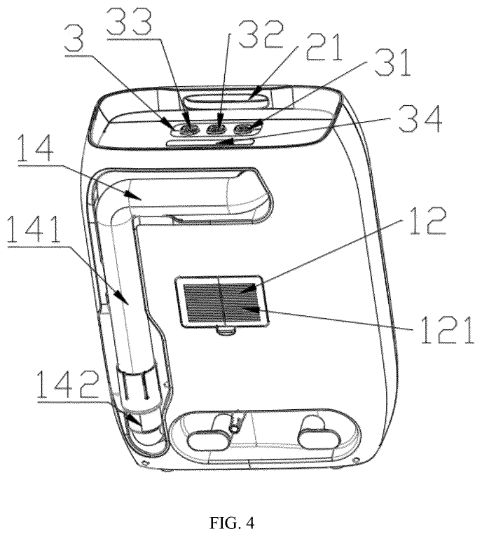

In a preferred embodiment, as shown in FIG. 2 and FIG. 4, the inlet 11 is connected to the dust bin 2 through a pipeline 14, at least a portion of the pipeline is placed outside the housing, the portion of the pipeline outside the housing is at least partially a hose 141, a detachable structure 142 is located at one end of the hose near the inlet, the hose is configured to be detachable from the detachable structure 142, one end of the hose near the detachable structure 142 is the hose suction nozzle. The pipeline outside the housing is at least partially the hose 141, meaning that the pipeline comprises a hose placed outside the housing. The hose is provided to configure two cleaning modes: a floor mode where dust is suctioned through the inlet, and an accessory mode where dust is suctioned through the hose. This diversifies the vacuum cleaner's functionality and makes it more convenient for users. For example, when cleaning areas other than the floor or when the user does not want to move the vacuum cleaner, the hose can be used for cleaning. Additionally, the hose suction nozzle can be configured with different suction heads, making cleaning more convenient.

A further preferred embodiment is that a second sensor is arranged on the detachable structure 142, and the second sensor is configured to detect whether the hose has been detached from the detachable structure. The second sensor is used to detect whether the vacuum cleaner is operating in the inlet suction mode (i.e., floor mode) or the hose suction nozzle mode (i.e., accessory mode), and transmits this information to the control system.

Preferably, as shown in FIG. 2 and FIG. 4, the pipeline 14 is connected to an upper portion of the dust bin 2.

In the embodiment, the pipeline extends from the inlet to the outside of the housing, and then extends upward into the housing to connect with the dust bin 2. Of course, this invention is not limited to this.

In addition, the hose can be designed with different lengths as needed. Preferably, a buckle slot is arranged on the housing, and the hose is clipped into the buckle slot. During use, the hose suction nozzle is removed from the detachable structure, and the hose body can be taken out from the buckle slot for use. This design does not take up extra space and is convenient for carrying and use.

In a preferred embodiment, the invention further comprises a control system, the control system comprises a control module, the control system is provided with a manual mode and an automatic mode, both the manual mode and the automatic mode are connected to the motor through a motor control module on the control module, and the automatic mode is also connected to the first sensor.

In the embodiment, the control system further comprises control buttons 3, the control buttons 3 are arranged on the housing 1, the control buttons 3 comprise a power switch 31, an activation button 32, and a mode switching button 33; the power switch 31 is configured to power on the vacuum cleaner. The activation button 32 is configured to start the manual mode of the control system. The mode switching button 33 is configured to switch between the manual mode and the automatic mode.

In the embodiment, as shown in FIG. 1-FIG. 4, the control system comprises the control buttons, and the control buttons comprise the activation button 32. The connection method of the manual mode is as follows: the activation button 32 is connected to the control module, and the control module is provided with the motor control module, and the motor control module is connected to the motor.

The connection method of the automatic mode is as follows: the first sensor is connected to the control module, the control module is provided with the motor control module, and the motor control module is connected to the motor.

In actual use, when the power switch is turned on and the vacuum cleaner detects vibrations from the external cleaning direction, the vibration sensor is triggered, and the vacuum cleaner enters the automatic mode. The vibration sensor controls the motor to perform suction work through the motor control module; after a certain period of time, the vacuum cleaner automatically stops working. Preferably, depending on actual usage, the vacuum cleaner motor's automatic working time in the automatic mode is 5-15 seconds. Further preferably, in the automatic mode, the vacuum cleaner motor's automatic working time is 6 seconds. Additionally, it should be noted that in the automatic mode, if the vibration sensor continuously detects vibrations, the vacuum cleaner will continue working until the vibrations stop.

Preferably, when the vacuum cleaner is operating in the automatic mode; at this time, if the mode switching button is pressed, the operating mode of the vacuum cleaner is switched to the manual mode.

When the vacuum cleaner is in the manual mode, the first sensor is not triggered, and the vacuum cleaner controls the motor to perform suction work; after a period of time, it stops work. Similarly, in the manual mode, the vacuum cleaner motor's automatic working time is preferably 5-15 seconds. Further preferably, in the manual mode, the vacuum cleaner motor's automatic working time is 6 seconds. Of course, if the vacuum cleaner is in the manual mode; at this time, the mode switching button is pressed, the vacuum cleaner will be switched to the automatic mode. Alternatively, if the vacuum cleaner is in the manual mode and the first sensor detects vibrations from the external cleaning direction, the first sensor will be triggered, and the vacuum cleaner's working mode will switch to automatic mode.

In the embodiment, the conventional use of the control buttons of the vacuum cleaner provided by the invention is to first press the power switch to power on the vacuum cleaner, and then press the activation button to put the vacuum cleaner into the manual mode; if the automatic mode is required, the mode switching button can be pressed to switch the working mode of the vacuum cleaner to the automatic mode.

In another preferred embodiment, the vacuum cleaner comprises the floor mode and the accessory mode; the vacuum cleaner adopts an inlet vacuuming mode as the floor mode, and the vacuum cleaner adopts a hose suction nozzle vacuuming mode as the accessory mode.

The specific implementation is as follows: when the second sensor detects that the hose suction nozzle has been removed from the detachable structure, the suction mode is configured by the control system to the accessory mode; when the second sensor detects that the hose suction nozzle has not been removed from the detachable structure, the suction mode is configured by the control system to the floor mode.

In the embodiment, the floor mode is initially configured by the control system to high-power suction, and the accessory mode is initially configured by the control system to low-power suction. Preferably, when the vacuum cleaner is in the accessory mode, pressing the mode switching button will switch the low-power suction of the accessory mode to high-power suction.

It should be noted that, in the floor mode, the mode switching button is configured by the control system to switch between the automatic mode and the manual mode; in the accessory mode, the mode switching button is configured by the control system to switch between high-power suction and low-power suction. In other words, the mode switch button can be controlled by the control system to switch between automatic mode/manual mode or floor mode/accessory mode.

In a preferred embodiment, the invention further comprises a power supply, and the power supply system provides power to the vacuum cleaner. In the embodiment, the vacuum cleaner is connected to an external power supply through a plug. Of course, this invention is not limited to this, and a battery can also be set to provide power to the vacuum cleaner.

In a preferred embodiment, as shown in FIG. 1-FIG. 2, the dust bin 2 is detachably arranged on the housing, a mistake-proofing sensor 15 is arranged on the housing. The mistake-proofing sensor 15 is configured to detect whether the dust bin 2 is opened or removed.

Preferably, the control module is provided with a mistake-proofing module. When the mistake-proofing sensor detects that the dust bin 2 is opened or removed, it sends a dust bin abnormal signal to the mistake-proofing module, and the mistake-proofing module keeps the motor off until the mistake-proofing sensor detects that the dust bin is installed on the housing. The mistake-proofing sensor and the mistake-proofing module play a mistake-proofing role, that is, if the mistake-proofing sensor detects that the dust bin is opened or removed, the vacuum cleaner will not work no matter how the start button is pressed.

In the embodiment, as shown in FIG. 2 and FIG. 4, a handle 21 is arranged on the dust bin 2, and the handle 21 facilitates the removal of the dust bin 2 from the housing or the removal of the dust bin 2. As shown in FIG. 1-FIG. 2, the dust bin 2 is snap-fitted to the housing. Of course, this invention is not limited to this; as long as the dust bin can be detached from and installed onto the housing, it is within the scope of the invention.

In a preferred embodiment, as shown in FIG. 1-FIG. 4, the control system further comprises a display panel 34, the control panel 34 is configured to display indicators such as manual mode or automatic mode, floor mode or accessory mode, high-power suction or low-power suction, dust bin or pipeline abnormality indications.

Preferably, a first filter is arranged between the dust bin 2 and the motor. The first filter is provided to prevent the garbage dust in the dust bin from entering the motor and affecting the life of the motor.

Preferably, the outlet is provided with a second filter 121. The second filter is provided to prevent dust falling inside the housing from being discharged outside the housing.

Preferably, a visual window 22 is arranged on the dust bin 2. Through the visual window, the garbage collection situation in the dust bin can be observed.

It should be noted that all the features of the above components can be freely combined without conflict. In addition, changes, modifications and modifications in the component structure are also within the protection scope of this invention.

In the description of this specification, reference terms “one embodiment”, “some embodiments”, “other embodiment”, “another embodiment”, “other embodiments”, “example”, “specific embodiment” or “some examples” etc. means that the specific features, structures, materials or characteristics described in conjunction with the embodiment or example are included in at least one embodiment or example of the invention. In this specification, the schematic representations of the above terms do not necessarily refer to the same embodiment or example. Moreover, the specific features, structures, materials or characteristics described can be combined in any one or more embodiments or examples in a suitable manner. In addition, those skilled in the art can combine different embodiments or examples described in this specification.

Although the embodiments of the invention have been shown and described above, it should be understood that the above embodiments are exemplary and should not be understood as limitations of the invention. Those skilled in the art can make changes, modifications, substitutions and alterations to the above embodiments within the scope of the invention without departing from the principles and spirit of the invention.

1. A vacuum cleaner that works by triggering a vibration sensor, comprising a housing, the housing is provided with an inlet and an outlet, the inlet is arranged at a bottom of the housing, a motor and a dust bin are arranged in the housing, the motor comprises a suction port and an exhaust port, the inlet is connected to the dust bin, the dust bin is connected to the motor, the exhaust port is connected to the outlet; the housing is also provided with a first sensor, the first sensor is a vibration sensor, the vibration sensor is configured to detect whether a broom or other cleaning tools have collided with the housing.

2. The vacuum cleaner that works by triggering the vibration sensor of claim 1, wherein the first sensor is arranged on the housing near the inlet.

3. The vacuum cleaner that works by triggering the vibration sensor of claim 2, wherein the first sensor is a spring-type vibration sensor; the direction of the spring's expansion and contraction for detecting sensitivity is aligned with the movement direction of the cleaning tool.

4. The vacuum cleaner that works by triggering the vibration sensor of claim 2, wherein multiple vibration sensors are arranged at intervals on the housing, and the multiple vibration sensors are connected in parallel.

5. The vacuum cleaner that works by triggering the vibration sensor of claim 1, wherein the inlet is connected to the dust bin through a pipeline, at least a portion of the pipeline is placed outside the housing, the portion of the pipeline outside the housing is at least partially a hose, a detachable structure is located at one end of the hose near the inlet, one end of the hose near the detachable structure is a hose suction nozzle.

6. The vacuum cleaner that works by triggering the vibration sensor of claim 5, wherein a second sensor is arranged on the detachable structure, and the second sensor is configured to detect whether the hose has been detached from the detachable structure.

7. The vacuum cleaner that works by triggering the vibration sensor of claim 1, further comprising a control system, the control system comprises a control module, the control system is provided with a manual mode and an automatic mode, both the manual mode and the automatic mode are connected to the motor through a motor control module on the control module, and the automatic mode is also connected to the first sensor.

8. The vacuum cleaner that works by triggering the vibration sensor of claim 6, wherein vacuuming methods of the vacuum cleaner comprise a floor mode and an accessory mode; when the second sensor detects that the hose suction nozzle has been removed from the detachable structure, the suction mode is configured by the control system to the accessory mode; when the second sensor detects that the hose suction nozzle has not been removed from the detachable structure, the suction mode is configured by the control system to the floor mode.

9. The vacuum cleaner that works by triggering the vibration sensor of claim 8, wherein the floor mode is initially configured by the control system to high-power suction, and the accessory mode is initially configured by the control system to low-power suction;
when the vacuum cleaner is in the accessory mode, pressing a mode switching button will switch the low-power suction of the accessory mode to high-power suction.

10. The vacuum cleaner that works by triggering the vibration sensor of claim 1, wherein the dust bin is detachably arranged on the housing, a mistake-proofing sensor is arranged on the housing, the mistake-proofing sensor is configured to detect whether the dust bin is opened or removed.
